(19) United States
(12) Patent Application Publication
(10) Pub. No.: US 2010/0188318 A1
(43) Pub. Date: Jul. 29, 2010

(54) DISPLAY DEVICE

(75) Inventors: Masato Ishii, Tokyo (JP); Naruhiko Kasai, Yokohama (JP); Tohru Kohno, Koganei (JP); Hajime Akimoto, Kokubunji (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(73) Assignees: Hitachi Displays, Ltd.; Canon Kabushiki Kaisha

(21) Appl. No.: 12/691,761

(22) Filed: Jan. 22, 2010

(30) Foreign Application Priority Data
Jan. 26, 2009 (JP) 2009-013849

(51) Int. Cl. G09G 3/30

(52) U.S. Cl. 345/76

(57) ABSTRACT

A display device includes: a display section including a plurality of pixels which emit light in an amount varied depending on an amount of current; signal lines for inputting a display signal voltage to the plurality of pixels; a switch circuit for switching between the signal lines to output signals corresponding to pixel states of the plurality of pixels, the pixel states being obtained through a supply of a detection-use power source to the plurality of pixels; and an A/D conversion section which includes a circuit for changing a reference voltage, and which sequentially detects signals corresponding to pixel states of pixels in each of a plurality of blocks which are obtained by dividing pixels in a horizontal line of the display section. The deteriorated pixels, which is accompanied by an in-plane gradient and fluctuations of the display section, are compensated without increasing a scale of a detection circuit.

### CROSS-REFERENCE TO RELATED APPLICATION

The present application claims priority from Japanese application JP2009-013849 filed on Jan. 26, 2009, the content of which is hereby incorporated by reference into this application.

### BACKGROUND OF THE INVENTION

1. Field of the Invention

The present invention relates to a display device, for example, a display device that includes self-luminous elements as its display elements.

2. Description of the Related Art

The propagation of various computers has produced various display devices designed to their specific roles. Among those display devices, so-called self-luminous display devices whose display elements are self-luminous elements are attracting attention. Known display devices of this type use organic electro luminescence (EL) elements or organic light emitting diodes as their display elements, for example. Self-luminous display devices do not need a backlight, which makes them suitable for low-power consumption uses, and have such advantages over conventional liquid crystal displays as higher pixel visibility and quicker response speed. Further, these light emitting elements have characteristics similar to those of diodes, which means that the luminance can be controlled via the amount of current let flow in the light emitting element. Self-luminous display devices are disclosed in, for example, JP 2006-91709 A.

In a display device structured as this, the characteristics of the light emitting elements thereof are such that the internal resistance value of the light emitting elements inevitably varies depending on the length of use and the surrounding environment. In particular, the nature of light emitting elements dictates that the internal resistance of a light emitting element that is in use for long rises with time, thus decreasing the amount of current flowing into the light emitting element. Accordingly, in cases where pixels in the same area in the screen of the display device are kept lit, for example, when displaying a menu, the burn-in phenomenon takes place in that place. Correcting this state requires detecting the pixel state. The pixel state is detected in a blanking period of displaying operation. In a blanking period, the emission does not occur so no voltage can be applied to the pixels. Another power source separate from one used for emission is therefore employed to apply a certain level of constant current to pixels in a blanking period, and voltage detection is made in this state, whereby degradations related to burn-in are detected from a change in voltage A known example of the correction method that involves pixel state detection is described in JP 2006-91860 A. In this example, monitoring elements are placed side by side in the row direction of light emitting elements of a display section, a base current source supplies a constant current to the monitoring elements, and voltages generated in the monitoring elements as a result are applied to a plurality of light emitting elements placed by the monitoring elements in the row direction, whereby the light emitting elements are driven on constant voltage.

### SUMMARY OF THE INVENTION

However, the display device described in JP 2006-91860 A can detect the state of pixels in the display section only in the row direction along which the monitoring elements are provided, and does not take into account fluctuation characteristics in the column direction. It is therefore desirable to detect the pixel state in each pixel separately but, in that case, an increase in scale of a circuit for detecting the pixel state is unavoidable. Therefore, there is a demand for a way to compensate for the display performance of deteriorated pixels, which is accompanied by an in-plane gradient and fluctuations of the display section, without increasing the scale of the detection circuit. Further, because the in-plane gradient and fluctuations of the display section may vary depending on individual panel characteristics, there is a serious demand for a correction technique that takes the in-plane gradient and fluctuations into account in compensating for the display performance of deteriorated pixels.

The present invention has been made in view of the above-mentioned problems, and it is therefore an object of the present invention to provide a display device capable of compensating for display performance of deteriorated pixels, which is accompanied by an in-plane gradient and fluctuations of a display section, without increasing a scale of a detection circuit.

Other objects of the present invention become clear by reading the description herein in its entirety.

In order to solve the above-mentioned problems, a display device according to the present invention includes: a display section including a plurality of pixels which emit light in an amount varied depending on an amount of current; signal lines for inputting a display signal voltage to the plurality of pixels; a switch circuit for switching between the signal lines to output signals corresponding to pixel states of the plurality of pixels, the pixel states being obtained through a supply of a detection-use power source to the plurality of pixels; and an A/D conversion section which includes a circuit for changing a reference voltage, and which sequentially detects signals corresponding to pixel states of pixels in each of a plurality of blocks which are obtained by dividing pixels in a horizontal line of the display section.

According to the display device of the present invention, the display performance of the deteriorated pixels, which is accompanied by the in-plane gradient and the fluctuations of the display section, can be compensated without increasing the scale of the detection circuit (A/D conversion section). Further, the influence of the in-plane gradient in the panel is suppressed, to thereby avoid an erroneous detection.

Other effects of the present invention become clear by reading the description herein in its entirety.

### BRIEF DESCRIPTION OF THE DRAWINGS

In the accompanying drawings:

FIG. 1 is a structural diagram outlining a display device according to a first embodiment of the present invention;

FIG. 2 is a diagram illustrating in detail the structure of the display device according to the first embodiment of the present invention;

FIG. 3 is an internal structural diagram illustrating an example of an A/D conversion section in the first embodiment of the present invention;

FIG. 4 is a diagram illustrating the internal structure of an example of an A/D circuit in the first embodiment of the present invention;

FIGS. 5A and 5B are diagrams illustrating one way to obtain all detected values when values detected along one horizontal line of a display area vary greatly in the display device according to the first embodiment of the present invention;

FIG. 6 is a diagram illustrating ideal line detection in pixel detection of the display device according to the first embodiment of the present invention;

FIG. 7 is a diagram illustrating a pixel detection state along one horizontal line in the display device according to the first embodiment of the present invention;

FIG. 8 is a diagram illustrating an erroneous pixel detection state;

FIGS. 9A and 9B are explanatory diagrams illustrating detection involving a block size adjustment which is a re-detection operation in the display device according to the first embodiment of the present invention;

FIG. 10 is a diagram illustrating the timing of a displaying operation and a detection operation in the display device according to the first embodiment of the present invention;

FIG. 11 is a control flow chart for causing a pixel to perform a displaying operation in the display device according to the first embodiment of the present invention;

FIG. 12 is a control flow chart for detecting a pixel in the display device according to the first embodiment of the present invention;

FIGS. 13A and 13B are explanatory diagrams illustrating a re-detection detection operation and a block position adjustment in a display device according to a second embodiment of the present invention;

FIG. 14 is a control flow chart for detecting a pixel in the display device according to the second embodiment of the present invention;

FIGS. 15A and 15B are explanatory diagrams illustrating a re-detection detection operation and an A/D threshold adjustment in a display device according to a third embodiment of the present invention;

FIG. 16 is a control flow chart for detecting a pixel in the display device according to the third embodiment of the present invention;

FIG. 17 is a diagram illustrating how a re-detection operation is selected in a display device according to a fourth embodiment of the present invention; and

FIG. 18 is a diagram illustrating an example of a user interface screen for selecting a re-detection operation in the display device according to the fourth embodiment of the present invention.

### DETAILED DESCRIPTION OF THE INVENTION

Embodiments of the present invention are described below with reference to the drawings. Throughout the drawings and the embodiments, identical or similar components are denoted by the same reference symbols in order to omit repetitive descriptions.

### First Embodiment

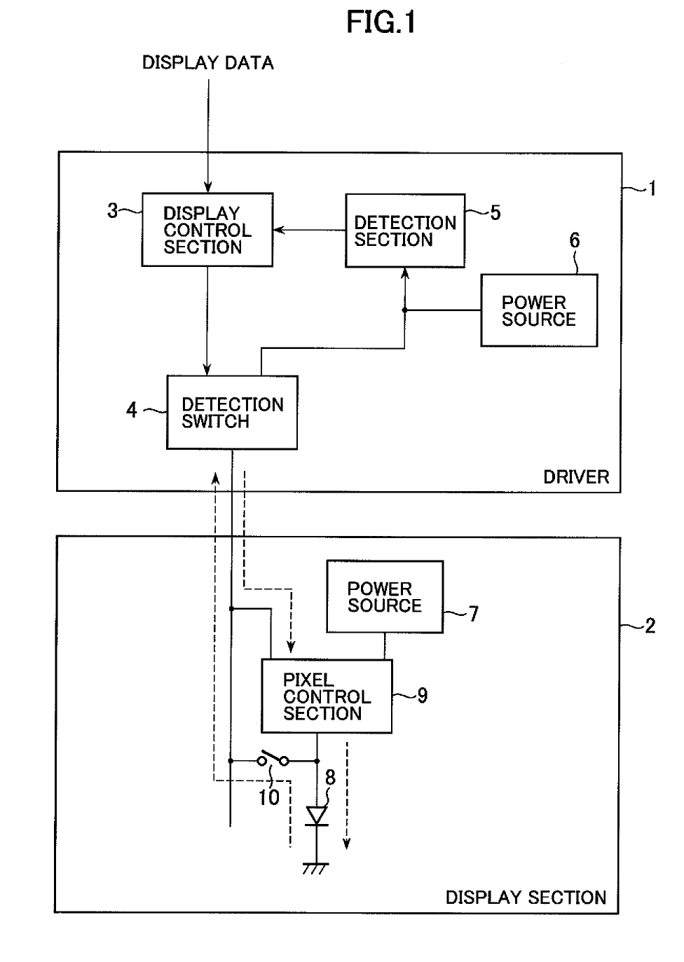

FIG. 1 is a schematic structural diagram of a display device according to a first embodiment of the present invention. The display device includes a driver 1 and a display section 2. The driver 1 includes a display control section 3, a detection switch 4, a detection section 5, and a detection-use power source 6. The display section 2 includes a display-use power source 7, a display element 8, a pixel control section 9, and a switch 10. Display data received from the outside is input to the display control section 3 of the driver 1. The display control section 3 performs timing control of the display data and signal control. There are roughly three different signal flows inside the driver 1, which are a display route, a detection route, and a correction route. On the display route, the display data enters the display section 2 via the display control section 3 and the detection switch 4, and then drives the display element 8 with the display-use power source 7 via the pixel control section 9. The detection route runs from the display element 8 to the detection section 5 via the switch 10 and the detection switch 4. The correction route runs from the detection section 5 to the display control section 3, and in the correction route, the display data is corrected. The detection switch 4 switches between a data direction for displaying and a data direction for detection. In a displaying operation, the display-use power source 7 is used as the power source of the display section 2 and, in a detection operation, the detection-use power source 6 is used as the power source of the display section 2. The number of power source, which is two in this embodiment, may be increased or decreased depending on the structure, and the power source type may also be varied between a current source and a voltage source depending on cases. The pixel control section 9 uses the display data to control the display-use power source 7 in the display operation and, in the detection operation, uses the detection-use power source 6 to transmit state data of the display element 8 to the detection section 5.

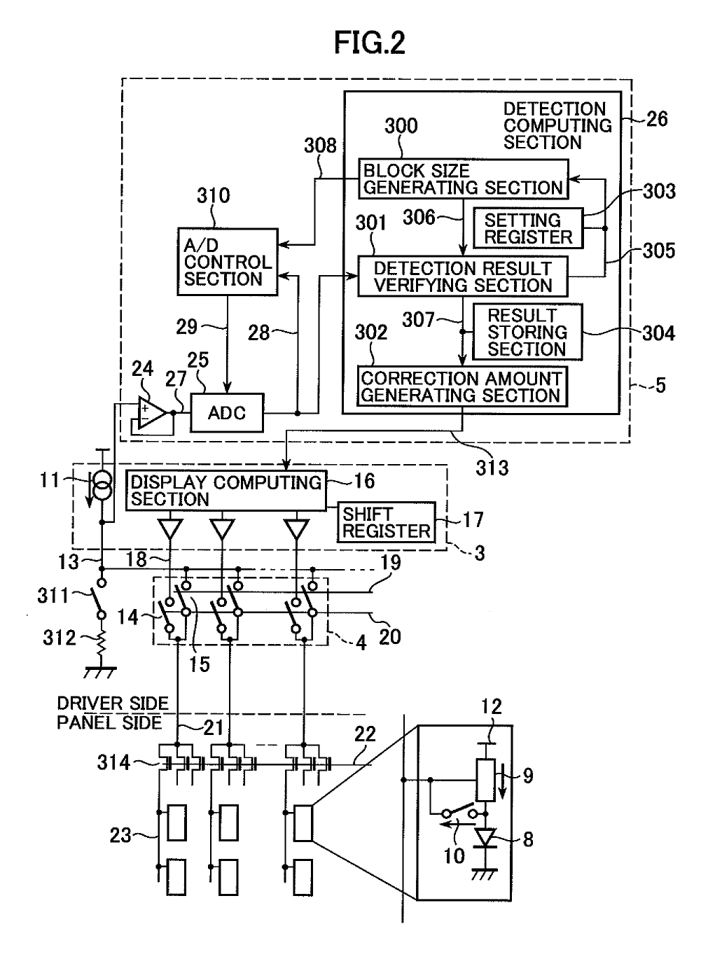

FIG. 2 is a diagram illustrating in detail the structure of the display device according to the first embodiment of the present invention illustrated in FIG. 1.

The display device includes an organic EL element as an example of the display element 8. The display element 8 is driven on separate power sources in the detection operation and in the displaying operation. In the detection operation, a detection-use current source 11 is used as the detection-use power source 6 and, in the displaying operation, a display-use voltage source 12 is used as the display-use power source 7. The display-use voltage source 12 is preferably shared by display elements that contribute to the displaying operation.

A switch 14 is connected to a display computing section 16 by a signal line 18, and is turned on in the displaying operation.

The detection-use current source 11 is connected to a switch 15 by a detection line 13. The switch 14 and the switch 15 are never turned on concurrently. The display computing section 16 controls the switches and the power sources, and performs detection and correction. A shift register 17 may be incorporated in the display computing section 16 or may be disposed as an independent control section, and is controlled by the display computing section 16. A signal line 21 is a shared line which is used in the displaying operation and the detection operation both. The switch 14 connected to the signal line 21 is controlled with a control signal 20, which is controlled by the display computing section 16, whereas the switch 15 is controlled with a control signal 19, which is controlled by the shift register 17. The display-use voltage source 12 and the display element 8 are connected to each other by the pixel control section 9. The detection-use current source 11 and the display-use voltage source 12 are separate power sources, but may be integrated into the current source or the voltage source depending on the detection structure. The signal line 21 and a signal line 23 are connected to each other by a switch 314, and the signal line 21 and the display element 8 are connected to each other by the switch 10. The switch 314 is controlled with a mode selection signal 22, which is controlled by the display computing section 16.

A result of detecting the pixel state is obtained in the detection section 5 via the detection line 13. The detection section 5 includes a buffer 24, an A/D conversion section 25, a detection computing section 26, and an A/D control section 310. The buffer 24 amplifies the value of the detection line 13 and outputs the amplified value as a signal 27. The A/D conversion section 25 converts the analog value of the signal 27 into a digital value of a signal 28. The detection computing section 26 calculates a correction amount from the digital value of the signal 28, and outputs the correction amount to the display computing section 16 via a signal 313. The A/D conversion section 25 is controlled with a control signal 29, which is sent from the detection computing section 26. The detection computing section 26 includes a block size generating section 300, a detection result verifying section 301, a correction amount generating section 302, a setting register 303, and a result storing section 304. The output of the block size generating section 300 is connected by a connection line 306 to the detection result verifying section 301. The output of the detection result verifying section 301 is connected by a feedback system connection line 305 to the setting register 303 and the block size generating section 300, and connected by a connection line 307 to the correction amount generating section 302 and the result storing section 304. Of the outputs of the detection computing section 26, the output of the block size generating section 300 is connected by a connection line 308 to the A/D control section 310, and the output of the correction amount generating section 302 is connected by a connection line 313 to the display control section 3. The detection method and various settings may be changed by changing setting values stored in the setting register 303 and the result storing section 304 in the detection computing section 26. The detection line 13 may include a switch 311 and a resistor 312 for a period in which the current source 11 is not in use.

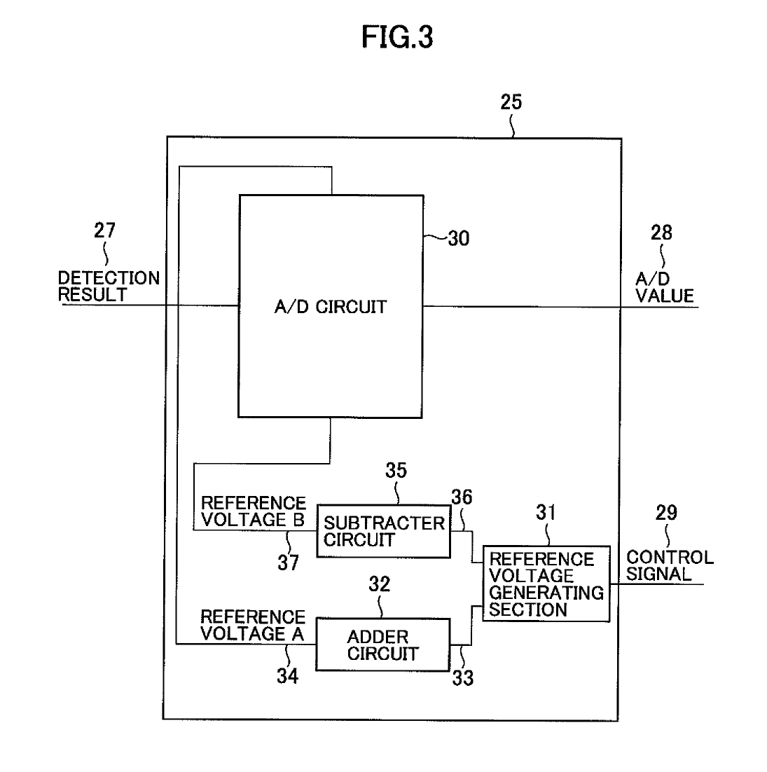

FIG. 3 is an internal structural diagram illustrating an example of the A/D conversion section according to the first embodiment of the present invention. As illustrated in FIG. 3, the signal 27 which indicates a detection result is input to the A/D conversion section 25, and the signal 28 which has undergone an A/D conversion in an A/D circuit 30 is taken out of the A/D conversion section 25 as an output. The A/D conversion section 25 has a structure including a reference voltage generating circuit 31, an adder circuit 32, and a subtracter circuit 35. The A/D conversion section 25 takes in the control signal 29 from the A/D control section 310, to which a signal 308 is input from the detection computing section 26 (see FIG. 2), and the control signal 29 is input to the reference voltage generating circuit 31. The reference voltage generating circuit 31 outputs a signal 33 and a signal 36. The signal 33 and the signal 36 may have the same value or different values. The signal 33 is input to the adder circuit 32, and the adder circuit 32 outputs a reference voltage A 34, which is supplied to the A/D circuit 30. The signal 36 is input to the subtracter circuit 35, and the subtracter circuit 35 outputs a reference voltage B 37, which is supplied to the A/D circuit 30. The reference voltage A 34 and the reference voltage B 37 are used as reference voltages of the A/D circuit 30.

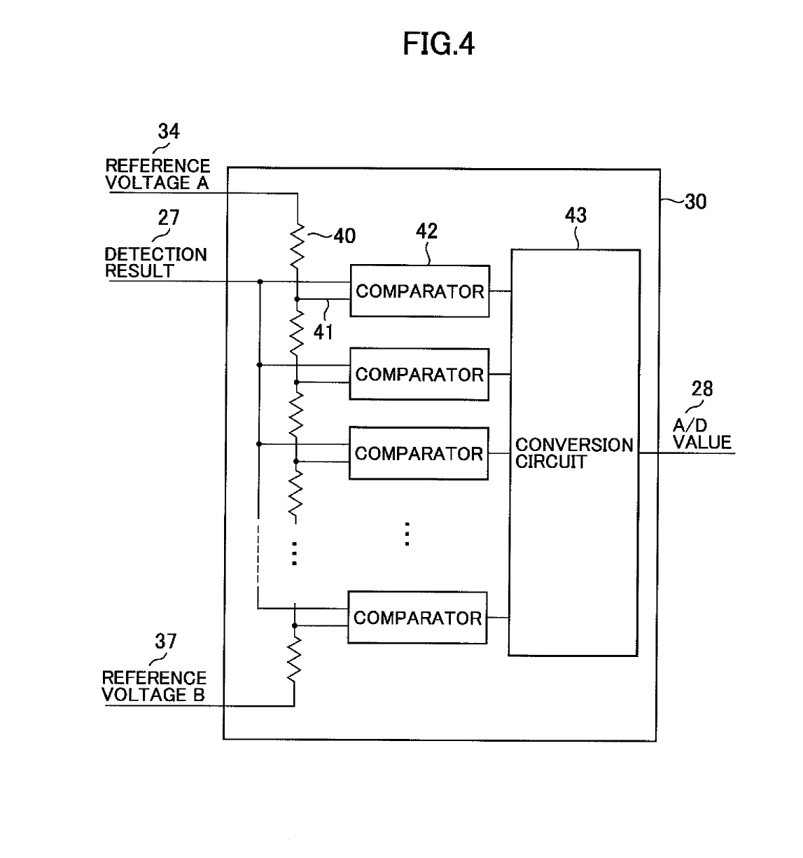

FIG. 4 is a diagram illustrating the internal structure of an example of the A/D circuit according to the first embodiment of the present invention. In FIG. 4, the A/D circuit 30 has a structure in which a comparator 42 is used to compare a reference value 41, which is generated from the reference voltage A 34 and the reference voltage B 37, with the input signal 27 indicating a detection result. One of the reference voltage A 34 and the reference voltage B 37 is chosen as a reference line value, which is obtained by adding an offset value to, or subtracting the offset value from, a reference voltage value. The reference value 41 used for the comparison is a value obtained by dividing the voltage between the reference voltage A 34 and the reference voltage B 37 by a predetermined number of resistor ladders 40. The comparator 42 compares the detection result signal 27 with the calculated reference value 41. In this embodiment, for example, seven comparators 42 are provided. The output from the comparator 42 is converted to the digital signal 28 of, for example, 3 bits by a conversion circuit 43. It should be noted, however, that the number of the comparators 42 and the number of the resistor ladders 40 may be increased or decreased according to the desired comparison accuracy.

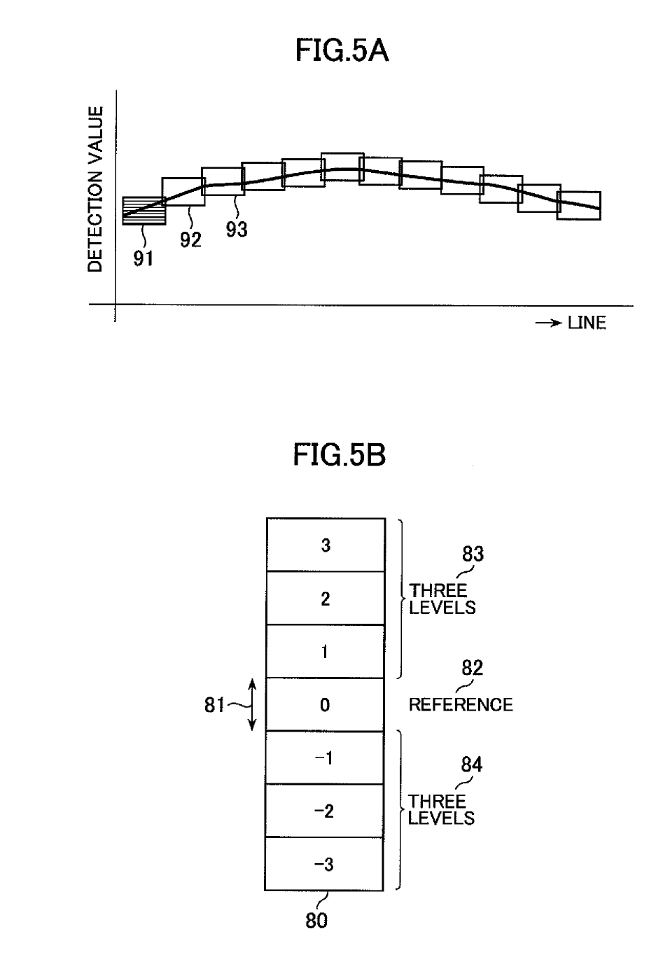

FIG. 5A illustrates a way to obtain all detected values when values detected along one horizontal line of a display area vary greatly in the display device according to the first embodiment of the present invention. As illustrated in FIG. 5A, small areas called blocks are numbered as a block 91, a block 92, a block 93 . . . in a manner that follows changes in detection value, and a detection result is obtained for each of the blocks 91, 92, 93 . . . . This way, despite the number of the comparators 42 in the A/D circuit 30 being as small as, for example, seven, detection results may be obtained by dividing a detection range into these blocks and moving from block to block in the horizontal direction. FIG. 5B is an enlarged view of the block 91 of FIG. 5A which illustrates the structure of a range 80. The minimum range of the range 80 of the A/D circuit 30 is a range 81 in the drawing. Within the range 81, a reference voltage 82 is placed in the middle, a three-level voltage range 83 is set on the plus voltage side, and a three-level voltage range 84 is set on the minus voltage side. The number of the voltage levels corresponds to the total number of the comparators 42 (seven in this embodiment), and corresponds to the number of the correction times.

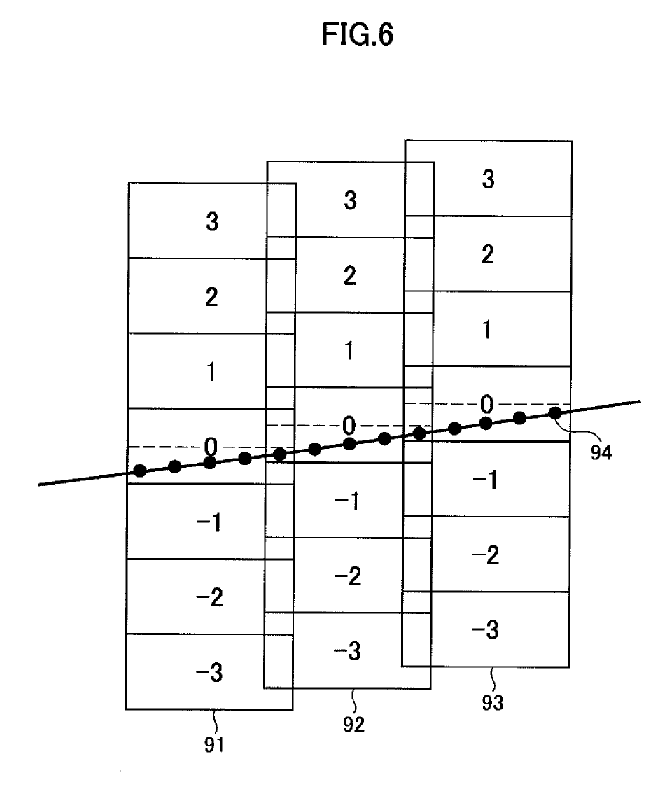

FIG. 6 is a diagram illustrating ideal line detection in pixel detection of the display device according to the first embodiment of the present invention. The minimum block width is initially set such that fluctuations among detection results that contain an in-plane gradient fall within a range half the minimum range. In FIG. 6, detection results 94 before deterioration along one horizontal line fall within a range half the minimum range of the block 91, the block 92, and the block 93. As is clear from FIG. 6, the display device of this embodiment is structured to sequentially detect the first to fifth pixels in each of the blocks 91 to 93 and obtain the detection results. The detection results may each be an absolute value, or may be a relative value obtained by calculating a differential between adjoining pixels. With the display device thus structured, the fifth black dot from the left in the drawing which is the last pixel in the preceding block (e.g., the block 91) is the first pixel in the second block, i.e., the block 92, and five (number of pixels to be detected) pixels counted from this pixel, specifically, the fifth to ninth black dots from the left in the drawing, are detected as pixels of the second block 92. Similarly, as many pixels as the number of pixels to be detected that are counted from the last pixel in the preceding block 92, specifically, the ninth to thirteenth pixels from the left in the drawing are detected in the third block, i.e., the block 93. By performing A/D conversion in this manner with one block and the next block sharing a pixel as the last pixel in the former block and the first pixel in the latter block, the continuity between blocks is secured reliably when the detection result is a relative value as described above.

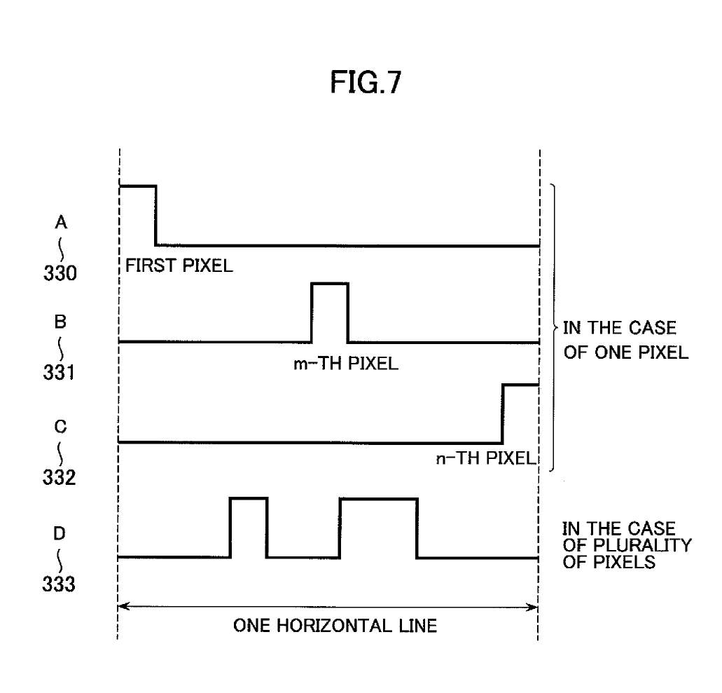

FIG. 7 is a diagram illustrating a pixel detection state along one horizontal line in the display device according to the first embodiment of the present invention. Specifically, parts A, B, and C of FIG. 7 illustrate detection results obtained when only one pixel in one horizontal line has deteriorated, and part D of FIG. 7 illustrates a detection result obtained when a plurality of pixels in one horizontal line have deteriorated. The number of pixels per horizontal line is n in this embodiment. In a case where the first pixel alone has deteriorated, the value changes only in the first pixel and does not change in the rest of the pixels as illustrated in part A of FIG. 7, i.e., a detection result 330. The detection result is converted into a relative value which is a differential between adjoining pixels. In a case where the m-th pixel in the middle alone has deteriorated, the value changes only in the m-th pixel and does not change in the rest of the pixels as illustrated in the detection result of part B of FIG. 7, i.e., a detection result 331. In a case where the n-th pixel alone has deteriorated, the value changes only in the n-th pixel and does not change in the rest of the pixels as illustrated in the detection result of part C of FIG. 7, i.e., a detection result 332. When a plurality of pixels in one horizontal line have been deteriorated, on the other hand, several detection edges are observed as illustrated in the detection result of part D of FIG. 7, i.e., a detection result 333. The display device of this embodiment is thus structured, as an example, to determine whether or not there is an erroneous detection by monitoring a rising edge and a falling edge of a detection output. Specifically, a pixel for which a rising edge of a detection output is detected is determined as a deteriorated pixel, and pixels preceding a pixel for which a falling edge of a detection output is detected are determined as deteriorated pixels. For example, in the detection result illustrated in part B of FIG. 7, where a rising edge is detected between detection results of the (m−1)-th pixel and the m-th pixel through the detection of the m-th pixel and a falling edge is detected between detection results of the m-th pixel and the (m+1)-th pixel through the detection of the (m+1)-th pixel, the m-th pixel alone is determined as a deteriorated pixel. Further, with a pair of a rising edge and a falling edge detected, it is determined that there is no erroneous detection.

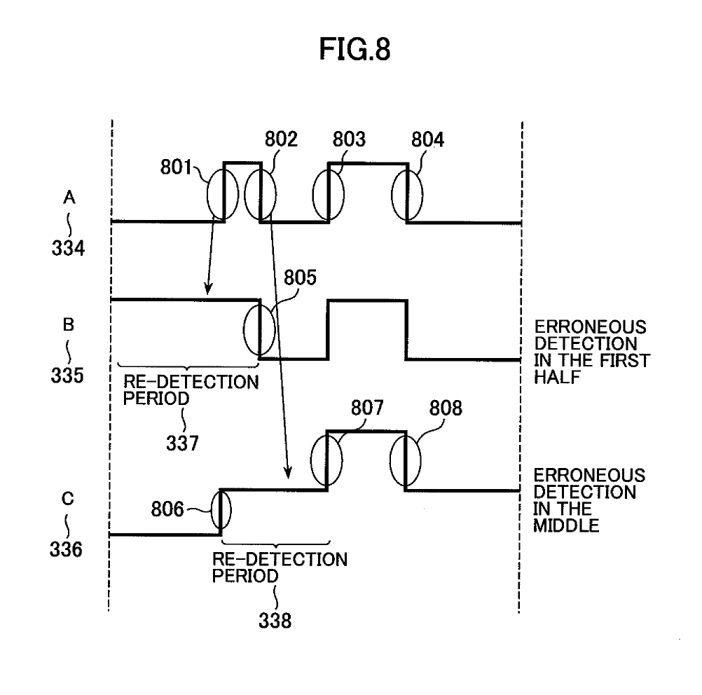

FIG. 8 is a diagram illustrating an erroneous pixel detection state along one horizontal line. Specifically, part A of FIG. 8 illustrates a state in which a detection is made normally, i.e., a detection of deterioration in a plurality of pixels as illustrated in part D of FIG. 7. Part B of FIG. 8 illustrates a state in which an erroneous detection is output in the front half of checking performed on one horizontal line of pixels. Part C of FIG. 8 illustrates a state in which an erroneous detection is output at the middle point of checking performed on one horizontal line of pixels. In the present invention, the cause of erroneous detection varies depending on the characteristics of the display section (display panel) such as the in-plane gradient and fluctuations among pixels, though the main cause is that the detection result signal 27 does not fall within a detection voltage range set for each block, in other words, the range between the reference voltage A 34 and reference voltage B 37 of each block. This embodiment therefore greatly reduces erroneous detections due to the characteristics of the display section by detecting an erroneous detection through the monitoring of a rising edge and a falling edge of a detection output, feeding back the result of the detection to change a setting value that is used in A/D conversion, and executing re-detection with the use of the changed setting value (condition).

As illustrated in part A of FIG. 8, i.e., a detection result 334, when there is no erroneous detection and deterioration is detected in a plurality of pixels, a rising edge 801 and a falling edge 802, which accompany the first deterioration detection output, or a rising edge 803 and a falling edge 804, which accompany the next deterioration detection output, are observed in the detection output. The display device of this embodiment accordingly monitors pixel locations at a pair of a rising edge and a falling edge, and detects pixels between the detection of the rising edge and the detection of the falling edge as deteriorated pixels. As a result, the display device of this embodiment detects, as deteriorated pixels, pixels that are associated with a detection result between the rising edge 801 and the falling edge 802 and pixels that are associated with a detection result between the rising edge 803 and the falling edge 804 illustrated in part A of FIG. 8.

Part B of FIG. 8, i.e., a detection result 335 illustrates a case where the first edge in the detection result 334 has failed to be detected. The detection result in this case may falsely recognize the pixels from the first pixel through the pixel at the right edge in part B of FIG. 8 as deteriorated pixels. Specifically, when a falling edge 805 alone is detected without detecting a rising edge first as illustrated in part B of FIG. 8, a pixel location associated with the rising edge 801 is not identified. Accordingly, which one of pixels preceding the detection of the falling edge 805 is the start of deterioration cannot be identified. Then, the first pixel to the pixel at the falling edge 805 (re-detection period 337) along the horizontal line in question need to undergo re-detection, and detection is executed again.

Part C of FIG. 8, i.e., a detection result 336 illustrates a case where the second edge in the detection result 334 has failed to be detected. The detection result in this case may falsely recognize pixels subsequent to the left edge as deteriorated pixels. Specifically, when the falling edge 802 is not detected as illustrated in part C of FIG. 8, a rising edge 807, which corresponds to the rising edge 803, and a falling edge 808, which corresponds to the falling edge 804, are detected after the detection of a rising edge 806, which corresponds to the rising edge 801. Accordingly, which one of pixels between the pixel where the first rising edge 806 is detected and the pixel where the next rising edge 807 is detected is deteriorated cannot be identified. Then, pixels associated with this re-detection period, which is denoted by 338, need to undergo re-detection, and detection is executed again.

Re-detection executed in parts B and C of FIG. 8 may be re-detection of entire of the line or re-detection of a part of the line. In this embodiment, a re-detection period is set and pixel detection is conducted under a detection condition unique to the re-detection period. Specifically, the re-detection period 337 is set in the case of the detection result 335 illustrated in part B of FIG. 8, the re-detection period 338 is set in the case of the detection result 336 illustrated in part C of FIG. 8, and pixels associated with the re-detection periods 337 and 338 are re-detected.

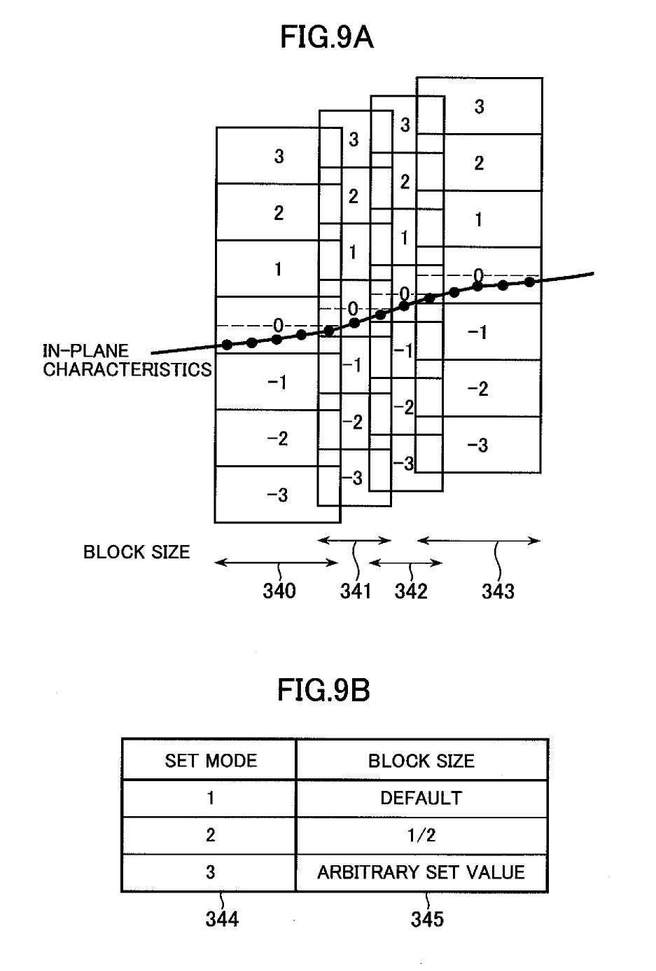

FIGS. 9A and 9B are explanatory diagrams illustrating detection involving a block size adjustment which is a re-detection operation in the display device according to the first embodiment of the present invention. Specifically, FIG. 9A is a diagram illustrating line detection in re-detection of pixels in the display device of the first embodiment, and FIG. 9B is a diagram illustrating the relation between an operation mode and a block size in re-detection.

In FIG. 9A, the in-plane gradient changes at a point and comes to exceed a range half the minimum range of the A/D circuit 30. Re-detection in this embodiment is executed by adjusting the block size. A block size 340 and a block size 343 have an initially set block size. A block size 341 and a block size 342, on the other hand, have a block size set for re-detection, for example, a block size set when the selected mode is a set mode “2”, which is described later.

As illustrated in FIG. 9B, setting values such as a set mode 344 and a set block size 345 are used to set a block size for re-detection. In this embodiment, three re-detection operation modes are provided. For example, re-detection in a set mode “1” may use initial setting values, re-detection in the set mode “2” may use a block size that is half of the initially set block size, and re-detection in a set mode “3” may use an arbitrary block size. Through this mode setting, the block size is readjusted and re-detection is executed. In the case where performing re-detection once does not eliminate erroneous detection, the block size readjustment and re-detection are executed again. The mode setting may be set in advance, or may be set by an operator who select settings interactively when the re-detection needs.

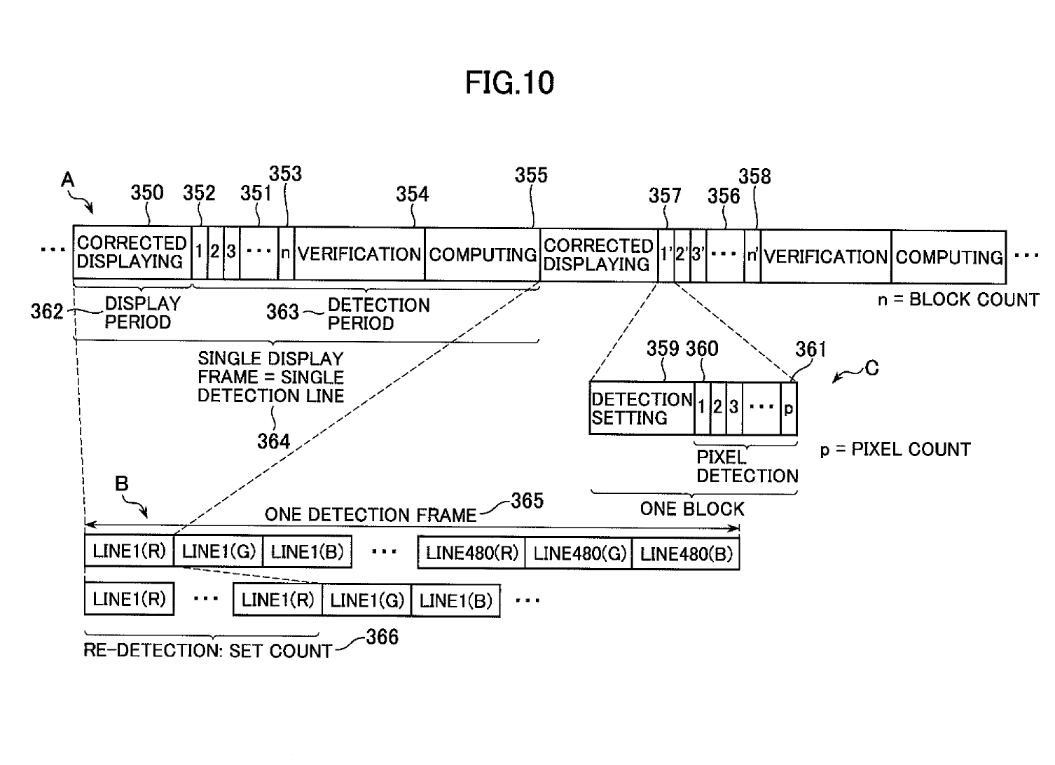

FIG. 10 is a diagram illustrating the timing of a displaying operation and a detection operation in the display device according to the first embodiment of the present invention. Specifically, part A in FIG. 10 illustrates a relation between a displaying operation and a detection operation for detecting pixel deterioration in an overall operation, part B in FIG. 10 illustrates a detection operation for detecting one horizontal line of pixels, and part C in FIG. 10 illustrates a block-based detection operation. In this embodiment, detection of one line is executed for, for example, display of each frame.

As illustrated in part A of FIG. 10, in the display device of the first embodiment, too, one frame in a displaying operation is made up of a display period and a blanking period, which are repeated in the subsequent frames. This embodiment allocates the blanking period to a detection period, and one frame is made up of a display period 350 and a detection period 351. In the display period 350, a corrected displaying operation based on detection results, namely, an image displaying operation adapted to pixel deterioration, is executed. Since the system is constructed as described above, an image displayed with deteriorated pixels whose deterioration is accompanied by the in-plane gradient and fluctuations of the display section may be corrected.

In the detection period 351, detection of one horizontal line which is divided into n blocks is executed block by block. In FIG. 10, a block 352 is the first block and a block 353 is the n-th block.

Similarly, a detection period 356 of the next frame is divided into n blocks, a block 357 is the first block, and a block 358 is the n′-th block. The detection period 351 includes verification 354 and computation 355 in addition to block detection. The verification 354 is for determining from a detection result whether or not there is an erroneous detection. The computing 355 is for generating a correction amount.

Part C in FIG. 10 illustrates details of each block in the detection period 356. In FIG. 10, a reference generating period and a pixel detection period are provided in one block. The A/D circuit is set through detecting setting 359 in the reference generating period, and then pixel detection is executed. In the pixel detection period, a pixel 360 is the first pixel and a pixel 361 is the p-th pixel. The number of pixels in one block, which is denoted by p, corresponds to a number obtained by dividing the total number of pixels in one horizontal line by the number of blocks n.

Part B in FIG. 10 illustrates a flow in a detection frame. A single display frame 364 which is one frame in a displaying operation is made up of a display period 362 and a detection period 363. A single detection frame in a detection operation is a detection frame 365. When an erroneous detection is detected in detection performed for each detection line, namely, horizontal line, re-detection is executed as many times as a set count 366. In detection according to this embodiment, a red (R) sub-pixel, a green (G) sub-pixel, and a blue (B) sub-pixel which are treated as one pixel are grouped by color. To detect deteriorated pixels, detection is performed separately for R sub-pixels, for G sub-pixels, and for B sub-pixels in a single detection line at a time, so that one pixel in one horizontal line which is constituted of R, G, and B sub-pixels is detected by performing three detection operations of a single detection line. Accordingly, when an erroneous detection is detected, re-detection for a horizontal line where the erroneous detection is detected (line 1(R) in the figure) is repeated as many times as the set count in the next detection period as illustrated in the lower half of part B of FIG. 10. The set count for re-detection is provided in order to avoid repeating a re-detection operation in the same place infinitely when performing re-detection a plurality of times does not eliminate an erroneous detection.

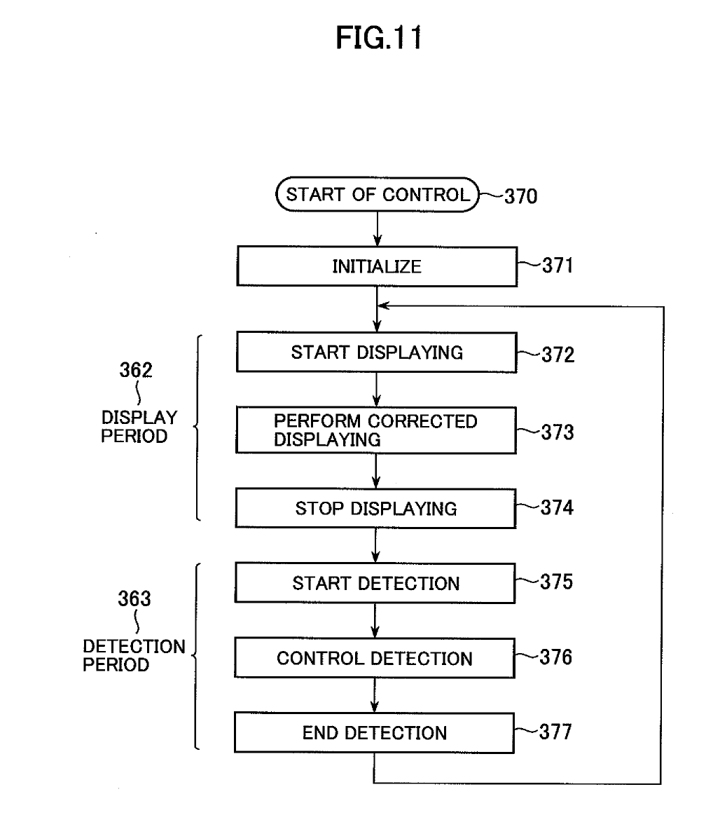

FIG. 11 is a control flow chart for causing a pixel to perform a displaying operation in the display device according to the first embodiment of the present invention. In FIG. 11, processing for a displaying operation is started in a processing step 370, and the system is initialized in a processing step 371. Thereafter, a display period 362 and a detection period 363 are repeated while the system is active. During the display period 362, displaying processing is started in a processing step 372, a corrected image is displayed in a processing step 373, and the displaying processing is ended in a processing step 374. During the detection period 363, detection processing is started in a processing step 375, detection control is executed in a processing step 376, and the detection processing is ended in a processing step 377. The display period 362 and the detection period 363 are contained within the single display frame 364 as described above.

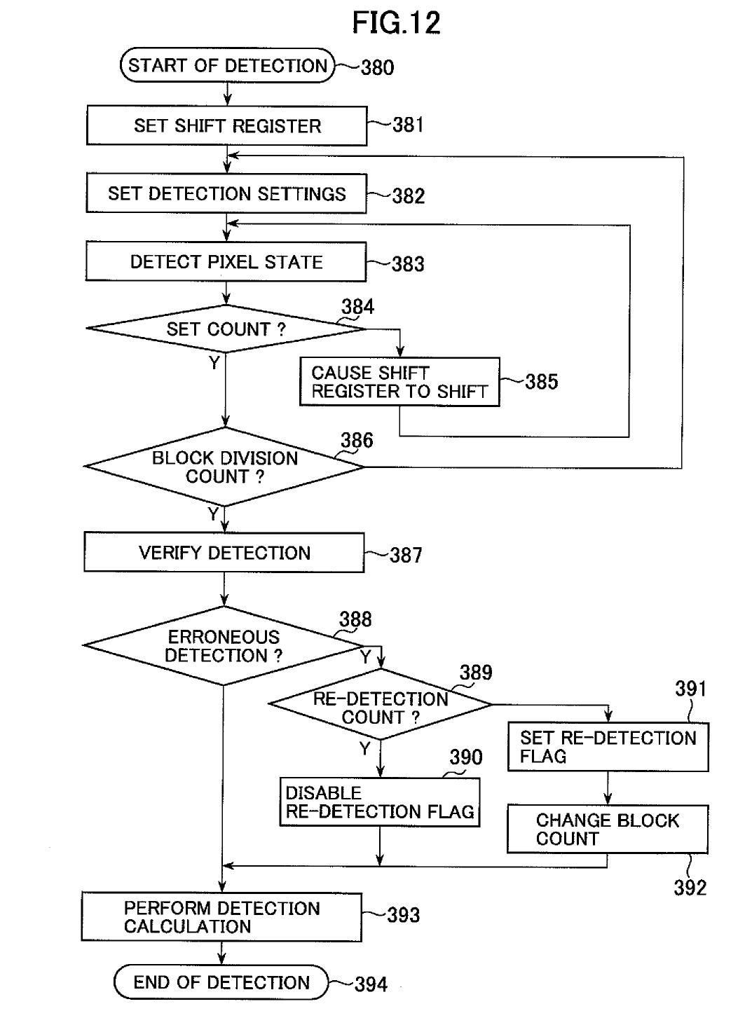

FIG. 12 is a control flow chart for detecting a pixel in the display device according to the first embodiment of the present invention, and illustrates details of the operation in the processing step 376 of FIG. 11. As illustrated in FIG. 12, detection control is started in a processing step 380, and the shift register (denoted by reference symbol 17 in FIG. 2) is set to be initialized in a processing step 381. Thereafter, a detection circuit is set in a processing step 382, and a pixel state is detected in a processing step 383. Whether or not the number of pixels in a block has reached a set number is determined in a processing step 384. When the set number has not been reached, the shift register is shifted in a processing step 385, and the processing step 383 and subsequent processing steps are repeated to detect each pixel in the block. When the number of pixels in the block has reached the set number in the processing step 384, whether or not the number of blocks has reached a set number is determined in a processing step 386. When the set number has not been reached, the processing step 382 and subsequent steps are repeated to detect all pixels in one horizontal line on a block basis. When the number of blocks has reached the set number in the processing step 386, a detection result is verified in a processing step 387 and, when no erroneous detection is found in a processing step 388, correction data is calculated from the detection result in a processing step 393. When an erroneous detection is found in the processing step 388, the detection operation moves to a processing step 389. When it is found in the processing step 389 that a set re-detection count has been reached, a re-detection flag is disabled in a processing step 390. When it is found in the processing step 389 that the set re-detection count has not been reached, the re-detection flag is set in a processing step 391, and the number of blocks is changed in a processing step 392. Thereafter, correction data is calculated from the detection result in the processing step 393, and the detection operation is ended in a processing step 394.

The operation of the display device according to the first embodiment of the present invention which is illustrated in FIGS. 1 to 12 is described next with reference to the flow charts of FIGS. 11 and 12.

As described above, when the display device of this embodiment is powered on, the control is started (processing step 370), and components of the driver 1 and the display section 2 including their respective control sections are initialized (processing step 371). Next, image display-use data and display data such as a displaying operation condition are input from an external system or the like to the display computing section 16 of the display control section 3 in order to start a displaying operation (processing step 372). The display data is corrected by a correction amount that is computed, for example, the last time a displaying operation is executed. The corrected display data is sequentially output via the switch 14 to the panel side, and written in the pixel control section 9 of each pixel in the first horizontal line to the last (e.g., 480th) horizontal line, whereby an image is displayed (processing step 373). At the time the preset image display period 350 ends, i.e., the blanking period (detection period) 351 begins in one frame period (processing step 374), a pixel deterioration check is started (processing step 375).

First, the shift register 17 is set to an initial value (processing step 381). Next, based on a detection method and various settings that are set to the setting register 303, the block size generating section 300 sets the number of pixels per block and the number of blocks per horizontal line to the A/D control section 310 and the detection result verifying section 301 (processing step 382). In this embodiment, the reference voltage A 34 and reference voltage B 37 of the A/D conversion section 25 are set at this point through control exerted by the A/D control section 310. The values set in this step may be determined based on, for example, detection values that are obtained the last time the same pixels are detected.

When this setting is finished, after the control signal 19 from the shift register 17 turns off the switch 14, the switches 10 and 15 are switched with the control signal 20, to thereby connect pixels to the detection-use current source 11 sequentially from the first pixel. At this point, a voltage applied to the display element 8 is amplified by the buffer 24, converted into digital data in the A/D conversion section 25, and then stored in the detection result verifying section 301 as data that indicates a pixel state (processing step 383). When the detection of the first pixel is completed, whether or not the set number of pixels per block has been reached by this pixel detection is determined (processing step 384). In the case where the set number has not been reached, the shift register 17 executes a shift operation (processing step 385), the switches 10 and 15 are controlled such that the next pixel on the horizontal line is detected, and the detection operation returns to the processing step 383. The processing steps 383 to 385 of the detection operation are repeated to detect pixels in one block sequentially.

When the number of pixels that have finished detection processing has reached the set number of pixels per block in the processing step 384, whether or not the number of blocks that have finished pixel detection has reached the preset block number is determined in the next processing step 386. In the case where the preset block number has not been reached, the detecting operation returns to the processing step 382, where the reference voltage A 34 and reference voltage B 37 of the A/D conversion section 25 are set under control of the A/D control section 310 to values suited to the measurement of the next block. The values set in this step are determined, as described above, based on the measured values of an adjacent block that has been measured. All pixels in one horizontal line are detected on a block basis by repeating the detection operation described above.

When the number of blocks that have finished the detection processing has reached the set number of blocks per horizontal line in the processing step 386, the detection result verifying section 301 detects whether or not a detection result includes an erroneous detection (processing step 387). As described above, an erroneous detection is detected in this embodiment by detecting a rising edge and a falling edge in a pixel detection result where a deteriorated pixel has been detected.

In the case where no erroneous detection is found as a result of this processing of detecting an erroneous detection (processing step 388), the correction amount generating section 302 calculates the degree of pixel deterioration based on the detection result of one horizontal line of pixels, and calculates a correction amount suited to the obtained degree of deterioration (processing step 393). The correction amount is output to the display computing section 16, at which point the detection operation is completed for one horizontal line of pixels (processing step 394).

In the case where the detection result verifying section 301 determines in the processing step 388 that there is an erroneous detection, the detection result verifying section 301 first checks the accumulated re-detection count (processing step 389). In the case where the accumulated re-detection count has not reached a preset re-detection count, the detection result verifying section 301 sets the re-detection flag (processing step 391). Based on a block size that is set in advance through the set mode and an erroneous detection range (re-detection period), the block size generating section 300 calculates values necessary for re-detection, including the number of blocks in the re-detection range (re-detection period), the number of pixels per block, and an initial value of the shift register 17. The calculated values including the number of blocks are set as a condition under which a re-detection operation is executed in the next frame (processing step 392). After the values including the number of blocks are calculated, the correction amount generating section 302 calculates the degree of pixel deterioration based on the detection result of one horizontal line of pixels, and calculates a correction amount suited to the obtained degree of deterioration (processing step 393). The correction amount is output to the display computing section 16, at which point the detection operation is completed for one horizontal line of pixels (processing step 394). However, because settings set in the processing step 392 are only for a re-detection operation necessitated by an erroneous detection, the detection operation may be ended in the processing step 394 immediately after the processing step 392, without calculating a correction amount for the current horizontal line in the detection calculation of the processing step 393.

In the case where the detection result verifying section 301 determines in the processing step 388 that there is an erroneous detection and the detection result verifying section 301 checks the accumulated re-detection count (processing step 389) to find out that the accumulated re-detection count has reached the preset re-detection count, the re-detection flag is disabled (processing step 390). After the re-detection flag is disabled, the correction amount generating section 302 calculates the degree of pixel deterioration based on the detection result of one horizontal line of pixels, and calculates a correction amount suited to the obtained degree of deterioration (processing step 393). The correction amount is output to the display computing section 16, at which point the detection operation is completed for one horizontal line of pixels (processing step 394). However, because aborting re-detection on the account that the accumulated re-detection count has reached a preset count leaves an erroneous detection unsolved, the detection operation may be ended in the processing step 394 immediately after the processing step 390, without calculating a correction amount for the current one horizontal line in the detection calculation of the processing step 393. Alternatively, when the correction amount for the current one horizontal line in the detection calculation of the processing step 393 is calculated, the degree of deterioration and a correction amount may be calculated only for other pixels than those where erroneous detection has not been solved.

As has been described, the display device of the first embodiment outputs a signal corresponding to the state of each pixel (pixel state), which is obtained through the supply of a detection current to the pixel from the detection-use current source 11 serving as the detection-use power source 6, by switching between the signal lines 13 and 18 with the use of the switches 14 and 15. In detecting a pixel state by applying the detection current from the detection-use current source 11 to each pixel, the A/D conversion section 25 sequentially detects signals in each of the blocks into, which are the groups of the pixels along a horizontal line of the display section 2, corresponding to the pixel states of the respective pixels in the block. At the same time, the reference voltage generating circuit 31 sequentially changes the reference voltage of the A/D conversion section 25 and measures voltages applied to the pixels. In addition, detection is repeated under newly set detection conditions in the case where an erroneous detection is detected when the detection computing section 26 determines the state of each pixel based on a detection result that is obtained by the A/D conversion section 25. The display device of the first embodiment can thus compensate for pixel deterioration which is accompanied by an in-plane gradient and fluctuations of the display section 2 without increasing the scale of a detection circuit that is constituted of the detection computing section 26 and other components. As a result, unevenness in a displayed image brought on by pixel deterioration such as burn-in is prevented. Another unique effect of the present invention is that, even when an erroneous detection is found, the erroneous detection can be corrected based on a detection result of one horizontal line of pixels.

In this embodiment, when an erroneous detection is found, the re-detection of a block in which the erroneous detection has been detected is executed with the block size fixed to a preset value. However, the present invention is not limited thereto and, for instance, the block size may be varied a little for each frame in which re-detection is executed.

### Second Embodiment

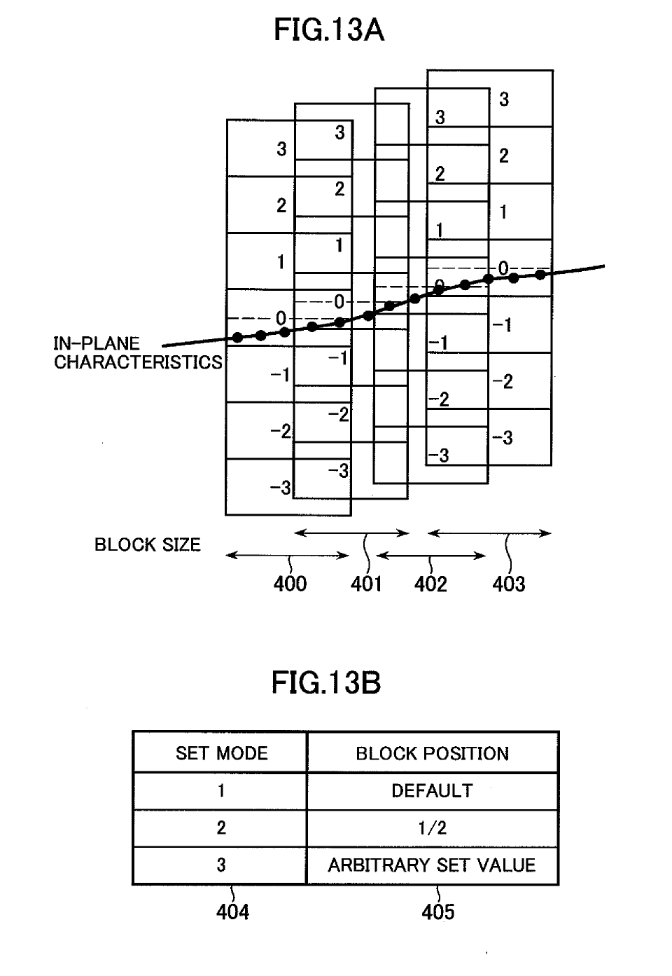

FIGS. 13A and 13B are explanatory diagrams illustrating a re-detection detection operation and a block position adjustment in a display device according to a second embodiment of the present invention. Specifically, FIG. 13A is a diagram illustrating line detection in re-detection of pixels in the display device of the second embodiment, and FIG. 13B is a diagram illustrating the relation between an operation mode and a block position in re-detection. The display device of the second embodiment is structured in the same way as the display device of the first embodiment, except for the components for the re-detection operation. Accordingly, the components for the re-detection operation alone are described in detail below.

As illustrated in FIG. 13A, the in-plane gradient changes at a point and comes to exceed a range that is half the minimum range of the A/D circuit. In the display device of this embodiment, the block division count, namely, the number of pixels in one block, is fixed and the re-detection of the erroneous detection area (erroneous detection period) is executed by adjusting the detection start position. A block size 400, a block size 401, a block size 402, and a block size 403 of FIG. 13A are each an initially set block size. This embodiment uses setting values such as a set mode 404 and set block position 405 illustrated in FIG. 13B to set a detection start position for re-detection. For instance, the detection start position in the set mode “1” is an initially set value, the detection start position in the set mode “2” is the start position that is half the initially set value, and the detection start position in the set mode “3” is an arbitrary start position. Through the mode setting described above, the detection position is readjusted and re-detection is executed with the block size fixed to the same size. In the case where performing re-detection once does not eliminate erroneous detection, the detection position readjustment and re-detection are executed again. The mode setting may be set in advance, or may be set by an operator who select settings interactively when the re-detection needs.

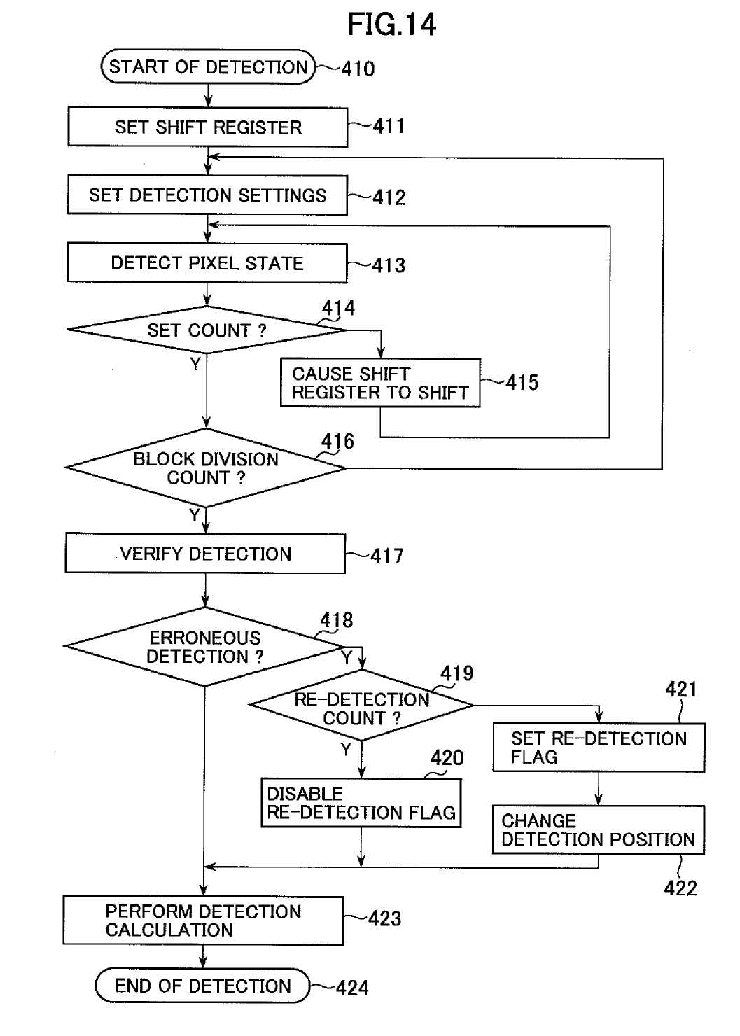

FIG. 14 is a control flow chart for detecting a pixel in the display device according to the second embodiment of the present invention, and illustrates details of re-detection operation in the second embodiment which corresponds to the operation of the display device of the first embodiment in the processing step 376 of FIG. 11. In other processing steps than a processing step 422, i.e. processing steps 410 to 421, 423, and 424, the detection operation of the display device in the second embodiment is the same as in the first embodiment.

As illustrated in FIG. 14, detection control is started in the processing step 410, and the shift register is set to be initialized in the processing step 411. Thereafter, the detection circuit is set in the processing step 412, and a pixel state is detected in the processing step 413. Whether or not the number of pixels in a block has reached a set number is determined in the processing step 414. When the set number has not been reached, the shift register is shifted in the processing step 415, and the processing step 413 and subsequent processing step are repeated to detect each pixel in the block. When the number of pixels in the block reaches the set number in the processing step 414, whether or not the number of blocks has reached a set number is determined in the processing step 416. When the set number has not been reached, the processing step 412 and subsequent processing steps are repeated to detect all pixels in one horizontal line on a block basis. When the number of blocks reaches the set number in the processing step 416, a detection result is verified in the processing step 417 and, when no erroneous detection is found in the processing step 418, correction data is calculated from the detection result in the processing step 423. When an erroneous detection is found in the processing step 418, the detection operation moves to the processing step 419. When it is found in the processing step 419 that a set re-detection count has been reached, a re-detection flag is disabled in the processing step 420. When it is found in the processing step 419 that the set re-detection count has not been reached, the re-detection flag is set in the processing step 421, and the redetection start position is changed in the processing step 422. Thereafter, correction data is calculated from the detection result in the processing step 423, and the detection operation is ended in the processing step 424.

The operation of the display device according to the second embodiment is described next with reference to FIGS. 13A, 13B, and 14. As mentioned above, the display device of the second embodiment is structured in the same way as the display device of the first embodiment, except for the components for the re-detection operation.

Accordingly, only the re-detection operation is described in detail below.

When the detection result verifying section determines in the processing step 418 of FIG. 14 that there is an erroneous detection, the detection result verifying section first checks the accumulated re-detection count (processing step 419). In the case where the accumulated re-detection count has not reached a preset re-detection count, the detection result verifying section sets the re-detection flag (processing step 421). With the block size (number of pixels per block) kept unchanged, based on a block position that is set in advance through the set mode and an erroneous detection range (re-detection period), the block size generating section calculates values necessary for re-detection, including the number of blocks in the re-detection range (re-detection period) and an initial value of the shift register. The calculated values including the number of blocks are set as a condition under which the re-detection operation is executed in the next frame (processing step 422). After the values including the number of blocks are calculated, the correction amount generating section calculates the degree of pixel deterioration based on the detection result of one horizontal line of pixels, and calculates a correction amount suited to the obtained degree of deterioration (processing step 423). The correction amount is output to the display computing section, at which point the detection operation is completed for one horizontal line of pixels (processing step 424). However, because settings set in the processing step 422 are only for a re-detection operation necessitated by an erroneous detection as in the first embodiment, the detection operation may be ended in the processing step 424 immediately after the processing step 422, without calculating a correction amount for the current one horizontal line in the detection calculation of the processing step 423. Alternatively, when a correction amount for the current one horizontal line in the detection calculation of the processing step 423 is calculated, the degree of deterioration and a correction amount may be calculated only for other pixels than those where erroneous detection has not been solved.

As has been described, the display device of the second embodiment repeats detection under detection conditions that include a newly set detection start position in the case where an erroneous detection is detected when the detection computing section 26 determines the state of each pixel based on a detection result that is obtained by the A/D conversion section 25. The display device of the second embodiment can thus compensate for pixel deterioration which is accompanied by an in-plane gradient and fluctuations of the display section 2 without increasing the scale of a detection circuit that is constituted of the detection computing section 26 and other components. As a result, unevenness in a displayed image brought on by pixel deterioration such as burn-in is prevented.

### Third Embodiment

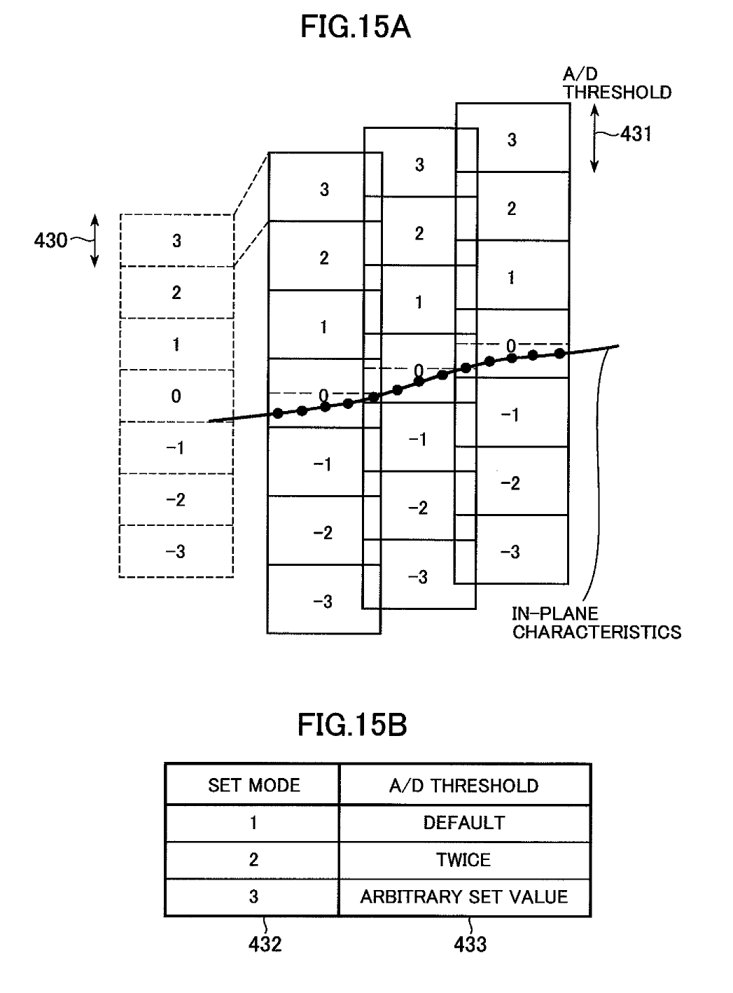

FIGS. 15A and 15B are explanatory diagrams illustrating a re-detection detection operation and an A/D threshold adjustment in a display device according to a third embodiment of the present invention. Specifically, FIG. 15A is a diagram illustrating line detection in re-detection of pixels in the display device of the third embodiment, and FIG. 15B is a diagram illustrating the relation between an operation mode and an A/D threshold in re-detection. The display device of the third embodiment is structured in the same way as the display device of the first embodiment, except for the components for the re-detection operation. Accordingly, the components for the re-detection operation alone are described in detail below.

As illustrated in FIG. 15A, the in-plane gradient changes at a point and comes to exceed a range that is half the minimum range of the A/D circuit. In the display device of this embodiment, the block division count and the detection start position are fixed and the re-detection is executed by adjusting the minimum range which is the threshold of the A/D circuit. In this embodiment, the threshold may be set in a range in which characteristics of pixels to be detected are sufficiently compensated. A range 430 is an initially set threshold. This embodiment uses setting values such as a set mode 432 and A/D threshold 433 illustrated in FIG. 15B to set an A/D threshold for re-detection. For instance, the A/D threshold in the set mode “1” is an initially set value, the A/D threshold in the set mode “2” is a value that is twice the initially set value, and the A/D threshold in the set mode “3” is an arbitrary multiple. Thus, in the display device of this embodiment, through the three kinds of mode setting, the minimum range of the A/D circuit is readjusted and re-detection is executed. In the case where performing re-detection once does not eliminate erroneous detection, the minimum range readjustment and re-detection are executed again. Similarly to the display device of the first and second embodiments described above, the mode setting may be set in advance, or may be set by an operator who select settings interactively when the re-detection needs.

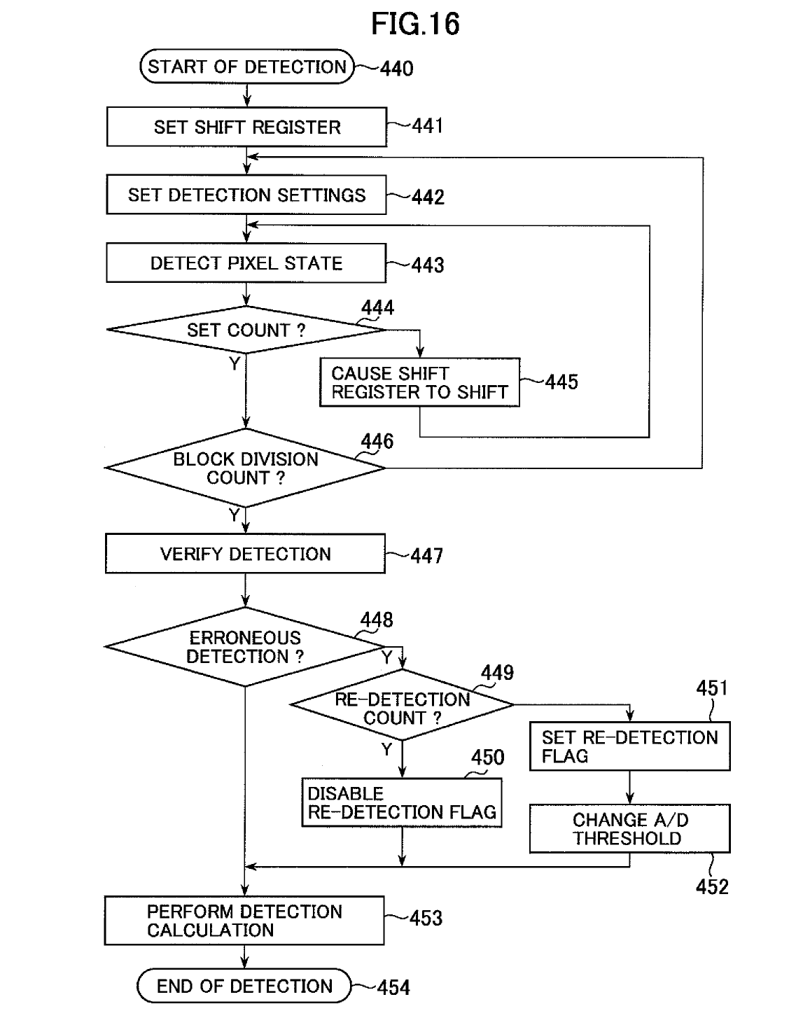

FIG. 16 is a control flow chart for detecting a pixel in the display device according to the third embodiment of the present invention, and illustrates details of re-detection operation in the third embodiment which corresponds to the operation of the display device of the first embodiment in the processing step 376 of FIG. 11. In other processing steps than a processing step 452 i.e. processing steps 440 to 451, 453, and 454, the detection operation of the display device in the third embodiment is the same as in the first embodiment.

As illustrated in FIG. 16, detection control is started in the processing step 440, and the shift register is set to be initialized in the processing step 441. Thereafter, the detection circuit is set in the processing step 442, and a pixel state is detected in the processing step 443. Whether or not the number of pixels in a block has reached a set number is determined in the processing step 444. When the set number has not been reached, the shift register is shifted in the processing step 445, and the processing step 443 and subsequent processing step are repeated to detect each pixel in the block. When the number of pixels in the block reaches the set number in the processing step 444, whether or not the number of blocks has reached a set number is determined in the processing step 446. When the set number has not been reached, the processing step 442 and subsequent processing steps are repeated to detect all pixels in one horizontal line on a block basis. When the number of blocks reaches the set number in the processing step 446, a detection result is verified in the processing step 447 and, when no erroneous detection is found in the processing step 448, correction data is calculated from the detection result in the processing step 453. When an erroneous detection is found in the processing step 448, the detection operation moves to the processing step 449. When it is found in the processing step 449 that a set re-detection count has been reached, a re-detection flag is disabled in the processing step 450. When it is found in the processing step 449 that the set re-detection count has not been reached, the re-detection flag is set in the processing step 451, and the minimum range of the A/D circuit is changed in the processing step 452. Thereafter, correction data is calculated from the detection result in the processing step 453, and the detection operation is ended in the processing step 454.

The operation of the display device according to the third embodiment is described next with reference to FIGS. 15A, 15B, and 16. As mentioned above, the display device of the third embodiment is structured in the same way as the display device of the first embodiment, except for the components for the re-detection operation. Accordingly, only the re-detection operation is described in detail below.

When the detection result verifying section determines in the processing step 448 of FIG. 16 that there is an erroneous detection, the detection result verifying section first checks the accumulated re-detection count (processing step 449). In the case where the accumulated re-detection count has not reached a preset re-detection count, the detection result verifying section sets the re-detection flag (processing step 451). Based on the A/D threshold 433 that is set in advance through the set mode 432, the A/D control section controls the reference voltage generating circuit to generate the reference voltages A and B necessary for re-detection, to thereby set an A/D threshold obtained based on the generated reference voltages A and B as a threshold to be used for the re-detection operation executed in the next frame (processing step 452). After the A/D threshold is changed, the correction amount generating section calculates the degree of pixel deterioration based on the detection result of one horizontal line of pixels, and calculates a correction amount suited to the obtained degree of deterioration (processing step 453). The correct ion amount is output to the display computing section, at which point the detection operation is completed for one horizontal line of pixels (processing step 454). However, because settings set in the processing step 452 are only for a re-detection operation necessitated by an erroneous detection as in the first embodiment, the detection operation may be ended in the processing step 454 immediately after the processing step 452, without calculating a correction amount for the current one horizontal line in the detection calculation of the processing step 453. Alternatively, when a correction amount for the current one horizontal line in the detection calculation of the processing step 453 is calculated, the degree of deterioration and a correction amount may be calculated only for other pixels than those where erroneous detection has not been solved.

As has been described, the display device of the third embodiment repeats detection under detection conditions that include a newly set minimum range which is a threshold of the A/D circuit in the case where an erroneous detection is detected when the detection computing section 26 determines the state of each pixel based on a detection result that is obtained by the A/D conversion section 25. The display device of the third embodiment can thus compensate for pixel deterioration which is accompanied by an in-plane gradient and fluctuations of the display section 2 without increasing the scale of a detection circuit that is constituted of the detection computing section 26 and other components. As a result, unevenness in a displayed image brought on by pixel deterioration such as burn-in is prevented.

### Fourth Embodiment

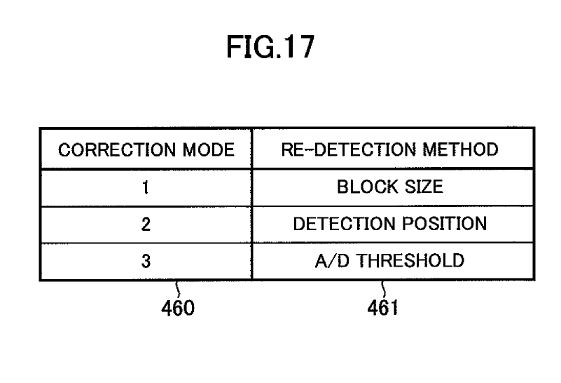

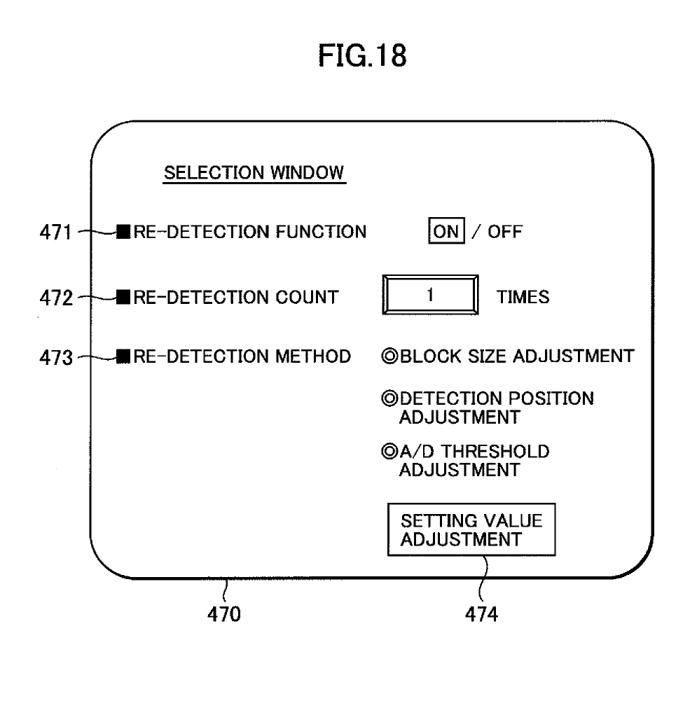

FIG. 17 is a diagram illustrating how a re-detection operation is selected in a display device according to a fourth embodiment of the present invention. FIG. 18 is a diagram illustrating an example of a user interface screen for selecting a re-detection operation in the display device according to the fourth embodiment of the present invention. The display device of the fourth embodiment includes all the components for the re-detection operation that the display devices of the first to third embodiments include. Because the components for the re-detection operation are the same as described above, what is described in detail below is a selection method for organizing the components for the re-detection operation. The display device of the fourth embodiment may include any two of the components for the re-detection operation that the display devices of the first to third embodiments include.

Setting values such as a correction mode 460 and re-detection method 461 illustrated in FIG. 17 are used to select a correction method for re-detection. For instance, a correction mode “1” uses re-detection that involves changing the block size, a correction mode “2” uses re-detection that involves changing the detection position, and a correction mode “3” uses re-detection that involves changing the minimum range of the A/D circuit. Through the correction setting of FIG. 17, an adjustment is made by a selected correction method and re-detection is executed. In the case where performing re-detection once does not eliminate erroneous detection, the readjustment of the block size, detection position, or A/D threshold and re-detection are executed again. In the fourth embodiment, the detection computing section 26 illustrated in FIG. 2 is provided with a correction method selecting section (not shown). When a re-detection operation is necessary in the processing steps 389, 419, and 449, after the re-detection flag is set (processing steps 391, 421, and 451), the correction method selecting section selects a suitable correction method from the correction settings illustrated in FIG. 17, and processing that corresponds to the selected correction method (processing steps 392, 422, and 452) is executed. The resultant unique effect is that the rate of success is high in re-detection of the erroneous detection area, in other words, the number of times that re-detection is executed in the erroneous detection area is reduced. Re-detection may be performed by selecting the three correction methods in turns until each correction method is selected a preset number of times. Alternatively, as described later, a detection method may be selected each time an erroneous detection is detected, or the user interface screen described later may have setting items so that a detection method is selected with the use of the user interface screen when an erroneous detection is detected.

FIG. 18 illustrates a user interface screen in this embodiment. A selection window 470 of the user interface screen has as setting items a re-detection function 471, a re-detection count 472, and a re-detection method 473. These setting items are given as an example, and the selection window 470 may have other setting items or other structures with no limitation.

The re-detection function 471 is for selecting whether to activate the re-detection operation. The re-detection count 472 is for setting how many number of times the re-detection operation is to be executed for a single detection operation. The re-detection method 473 is for selecting which of the correction modes, the block size adjustment, the detection position adjustment, and the A/D threshold adjustment, is to be executed. A setting value adjustment 474 is for changing the setting values of the re-detection methods. In the case where the setting value adjustment 474 is a push button, for example, a separate menu for various setting values is displayed by depressing the button.

When an erroneous detection is detected, the correction method selecting section selects a re-detection operation based on these selection items. Correction can thus be made through a desired detection method.

The above-mentioned first to fourth embodiments describe cases of applying the present invention to a display device that uses organic EL elements as display elements. However, the present invention is not limited to display devices that use organic EL elements as display elements, and is also applicable to display devices that use as their display elements other self-luminous elements such as organic light emitting diodes and inorganic EL elements.

While there have been described what are at present considered to be certain embodiments of the invention, it is understood that various modifications may be made thereto, and it is intended that the appended claim cover all such modifications as fall within the true spirit and scope of the invention.

What is claimed is:

1. A display device, comprising:
a display section including a plurality of pixels which emit light in an amount varied depending on an amount of current;
signal lines for inputting a display signal voltage to the plurality of pixels;
a switch circuit for switching between the signal lines to output signals corresponding to pixel states of the plurality of pixels, the pixel states being obtained through a supply of a detection-use power source to the plurality of pixels; and
an A/D conversion section which comprises a circuit for changing a reference voltage, and which sequentially detects signals corresponding to pixel states of pixels in each of a plurality of blocks which are obtained by dividing pixels in a horizontal line of the display section.

2. The display device according to claim 1,
wherein the A/D conversion section comprises:
a reference voltage generating circuit;
an adder circuit; and
a subtracter circuit, and
wherein the A/D conversion section uses the adder circuit to generate a reference voltage around a voltage of the reference voltage generating circuit, and uses the subtracter circuit to generate another reference voltage around the voltage of the reference voltage generating circuit.

3. The display device according to claim 2, wherein the A/D conversion section comprises a plurality of comparators for generating a plurality of reference states from a pixel state output of a first pixel of two arbitrary pixels, and comparing the plurality of reference states with a pixel state output of a second pixel of the two arbitrary pixels.

4. The display device according to claim 1, wherein, from results of detection obtained for each of blocks having an arbitrary number of divided pixels in one horizontal line of the display section, the A/D conversion section newly sets a detection condition of the arbitrary number of divided pixels in the one horizontal line.

5. The display device according to claim 4, wherein, in detection of pixels in successive blocks, a last detection pixel of a first block and a first detection pixel of a next block are the same pixel.

6. The display device according to claim 4, further comprising a means for changing a setting value of a detection computing section from the results of the detection of the pixels in the one horizontal line.

7. The display device according to claim 6, wherein the means for changing the setting value of the detection computing section changes a number of pixels in the each of the blocks.

8. The display device according to claim 6, wherein the means for changing the setting value of the detection computing section changes a detection start position of the each of the blocks in the one horizontal line.

9. The display device according to claim 6, wherein the means for changing the setting value of the detection computing section changes a minimum range of the A/D conversion section.

10. The display device according to claim 6, further comprising a user interface for selecting the means for changing the setting value of the detection computing section.

11. The display device according to claim 1, further comprising a detection computing section for determining the pixel states of the plurality of pixels based on results of the detection, and repeating the detection under a detection condition newly set from a result of the determination.
